(19) United States
(12) Patent Application Publication
(10) Pub. No.: US 2008/0240147 A1
(43) Pub. Date: Oct. 2, 2008

(54) Media Access Control (MAC) for low-cost, low power sensor networks

(76) Inventors: Chunming Qiao, Williamsville, NY (US); Seokhoon Yoon, Amherst, NY (US); Raghuram Sathyam Sudhaakar, Buffalo, NY (US)

Correspondence Address: Chunming Qiao, 8186 Melissa Renee Ct., Williamsville, NY, 14221, US

(21) Appl. No.: 12/059,759

(22) Filed: Mar. 31, 2008

Related U.S. Application Data
(60) Provisional application No. 60/920,716, filed on Mar. 29, 2007.

(51) Int. Cl. H04L 29/02

(52) U.S. Cl. 370/458

(57) ABSTRACT

This invention proposes unique methods and apparatus for networking low cost low energy sensor nodes. The invention focuses on efficient Media Access Control (MAC) schemes to provide differentiated Quality of Service (QoS) to the sensor nodes in single-hop wireless and wired networks where the source nodes do not have a receiver module. Hence they can only transmit data to a sink but cannot receive any control signals, like an ACK or NAK, from any other node. None of the existing schemes like polling or scheduled transmissions, CSMA or ARQ is thus effective in this type of networks. The proposed scheme provides QoS to the nodes using distributed control by allowing them to transmit each packet an optimal number of times within a given interval.

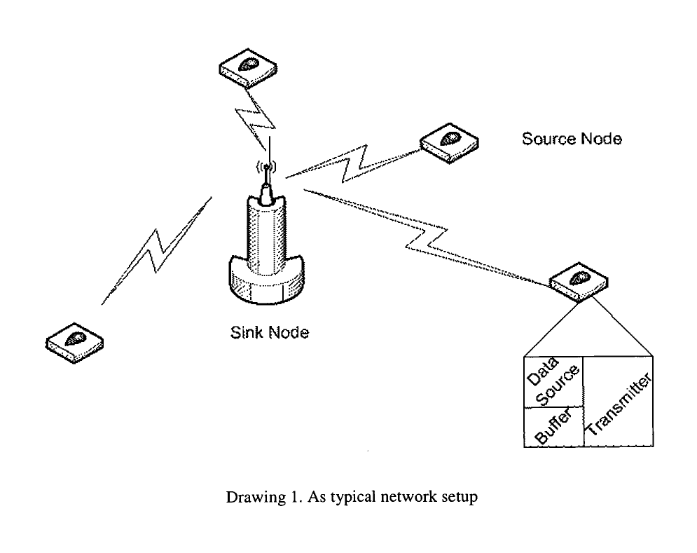

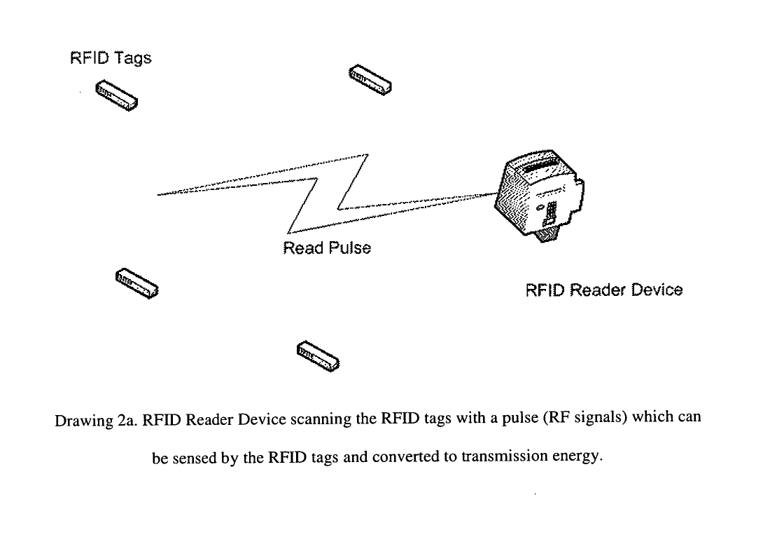

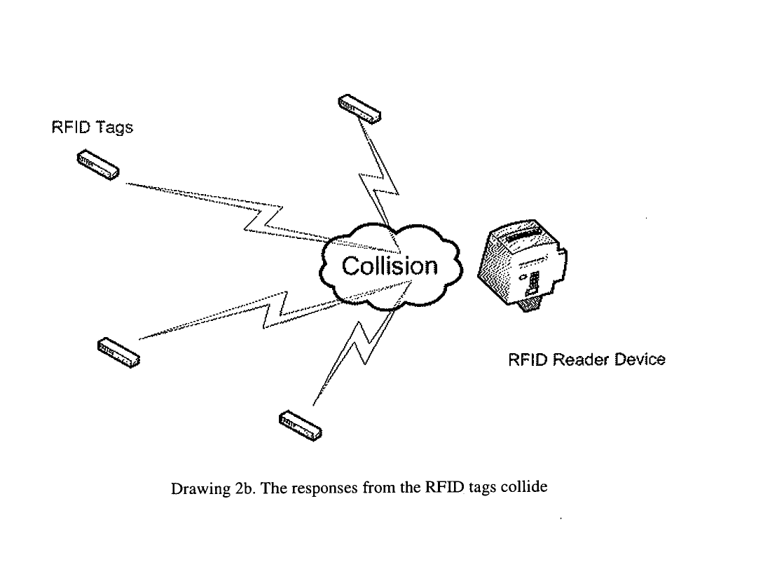

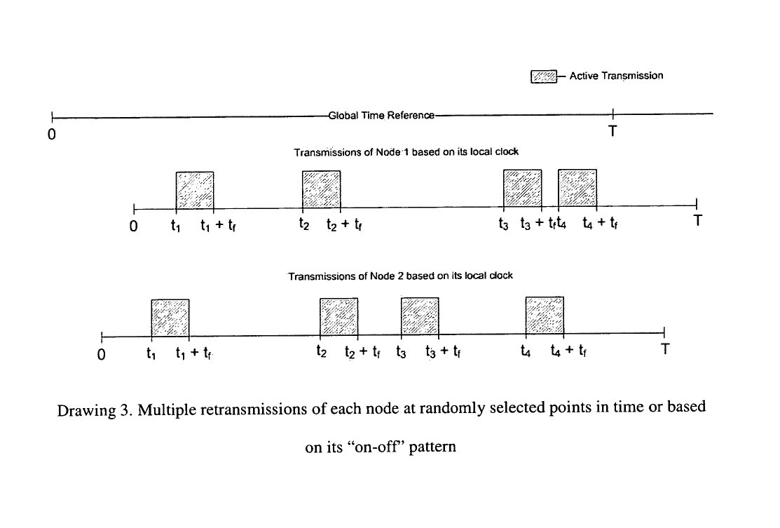

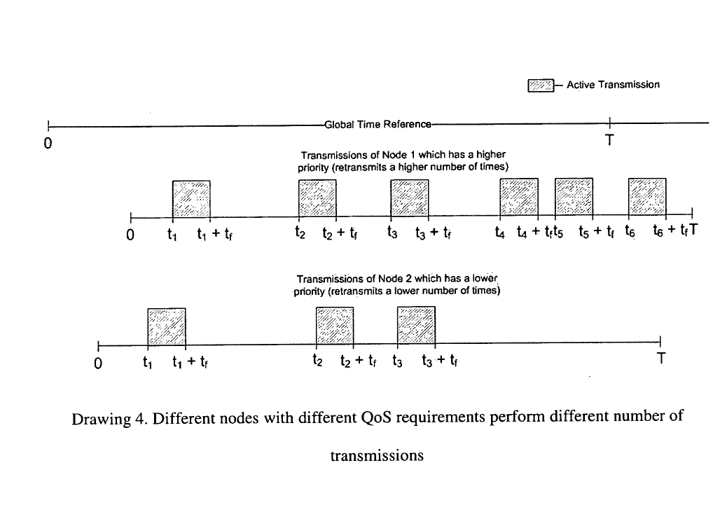

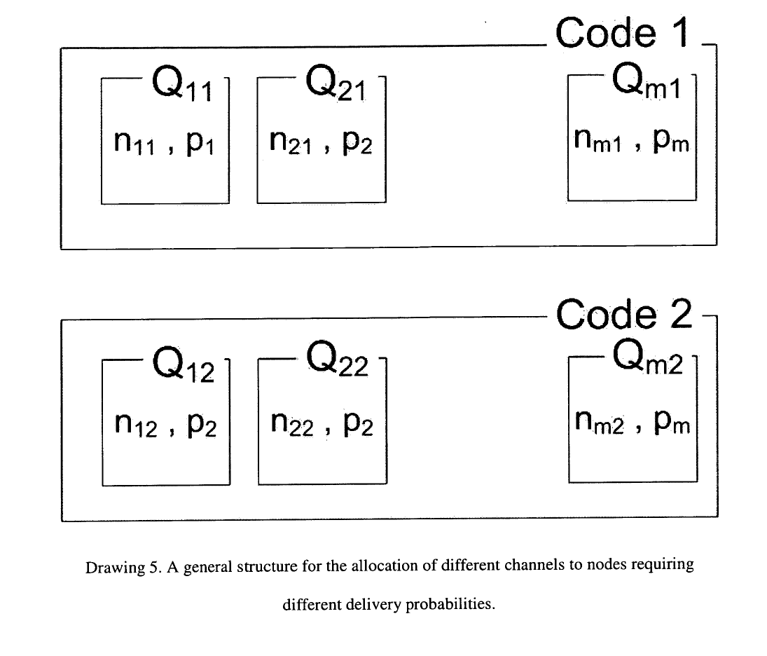

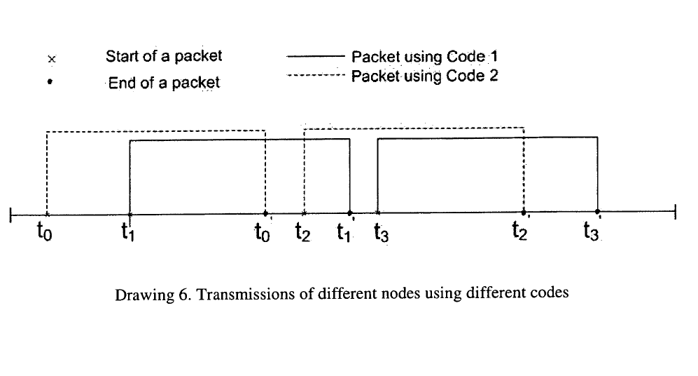

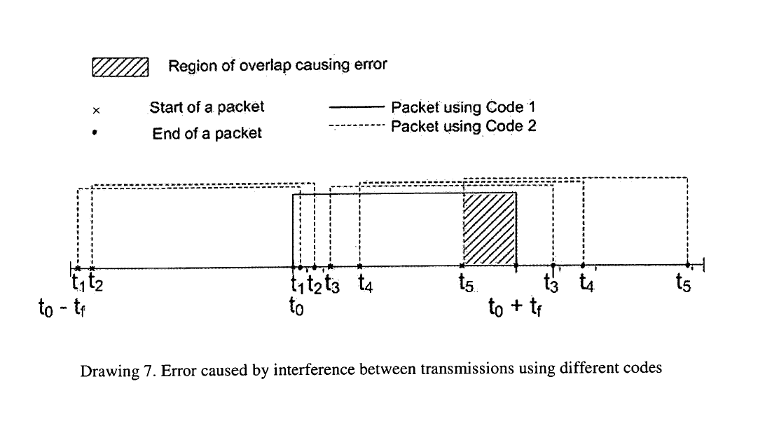

### RELATED APPLICATIONS

This application claims priority to Provisional Patent Application, Ser. No. 60/920,716, filed Mar. 29, 2007.

### FIELD OF THE INVENTION

This invention is in the field of communications in sensor networks, including wireless and RFID network, and relates to the application of unique methods and apparatus for Media Access Control (MAC) to reduce the hardware cost and to provide differentiated Quality of Service (QoS) to the sensor nodes.

### BACKGROUND OF THE INVENTION

Present day wireless/wired sensor networks and RFID-based passive networks are employed for a wide range of applications such as Smart Home, Green House Monitoring, Medical Monitoring, Intra-Vehicular Networks, Intelligent Transportation, and Inventory Management Systems. These networks typically consist of one (or a few) sink node(s) and a large number of data source nodes, each of which generates data and transmits it to the sink node(s) through a common communication medium (e.g., wireless channel, wired medium). In order to enable large scale deployments of such networks it is desirable that each source node be a low complexity, low cost device that can provide the performance of existing devices.

In general, such network deployments use devices that have both transmitting and receiving capability. However, in most applications we notice that the devices generally collect data and transmit it to a sink node. There is very minimal communication from the sink node to the data source nodes. The receiver circuitry adds to the cost of the device and also consumes a significant amount of power during operation. Thus by using nodes that have only transmitters and no receivers, the device cost and the entire infrastructure cost can be considerably reduced.

An important aspect of deploying such networks is to choose a suitable Media Access Control (MAC) scheme for accessing the shared communication channel (eg. wireless medium). It is also important that the MAC scheme is able to provide differentiated Quality of Service (QoS) to the nodes. For example, in an intra-vehicular network, the data generated by a sensor node that senses the status of the brakes is more important than that generated by a sensor node sensing the status of the tail lights. Hence the data transmitted by the brake sensor must be given priority over the tail light sensor.

Another important consideration is the lifetime of the network. Since in most cases the nodes are battery powered, it is important that they are very energy efficient in order that the lifetime and hence the cost of operation of the network is maximized. The MAC scheme plays a significant role in conserving energy as it controls the physical layer (eg. radio module) which is the major consumer of power in any network device.

Existing MAC protocols can be largely categorized into polling based, scheduled transmissions, Carrier Sense Multiple Access (CSMA), Automatic Repeat reQuest (ARQ) based schemes. However, all these techniques require that all nodes have the capability to receive. This is due to the fact that all the schemes need to provide some form of feedback to the nodes in order to guarantee differentiated Quality of Service. But, for the networks we consider in this work, the nodes do not have the capability to receive. Hence it is impossible to use the existing MAC schemes.

The invention addresses this problem by eliminating the need for feedback mechanisms. The MAC scheme developed in this work is capable of providing differentiated quality of service to the nodes and also ensures an energy efficient design.

### SUMMARY OF INVENTION

The following paragraphs describe the methods used for media access control and differentiated QoS in low cost and energy efficient sensor or RFID networks, in which, the sensor nodes are only capable of transmitting data and cannot receive any signals.

The primary approach is to allow each node to transmit each of its data frames multiple times, thus increasing the probability of delivery. The fact that data frame transmission duration is relatively small when compared to the data generation rate makes retransmissions of data frames before the generation of the next data frame meaningful and forms the basis of the invented method. In addition, if a frame cannot be successfully delivered within a data generation interval, T units of time, the data frame is simply discarded. This ensures that the latest data frame has a greater chance of being successfully delivered and also bounds the latency. Accordingly, the latency is randomly distributed in the interval (0, T) and is bounded by T.

However, the problem posed by this approach is that, if all the nodes follow a greedy approach and try to transmit their data a large number of times it will result in a large number of collisions and the number of successful transmissions will be very small (see Diagram 2). Thus the maximum delivery probability that can be achieved by each individual node will eventually be decreased.

Hence, the optimal number of retransmission that each node should attempt for each of its data frames is determined in the invented method, so that all the nodes in the network achieve their required QoS in terms of data delivery probability.

Specifically, the sensor nodes are classified into multiple QoS classes according to their data generation rate and required QoS in terms of frame delivery probability. Suppose that there are m QoS classes, {Q₁, . . . , Qₘ}, and each class contains (n₁, . . . , nₘ) nodes respectively. Each node in Qᵢ requires a minimum frame delivery probability of pᵢ (1≦i≦m). The packet arrival rates of the nodes in each class are {T₁, . . . , Tₘ} respectively. Given the classified nodes and QoS requirement, the optimal number of retransmissions, xᵢ, for each Qᵢ is determined using NLP (Non-Linear Programming) or NLIP (Non-Linear Integer Programming), such that, if every node in a Qᵢ transmits xᵢ times in every Tᵢ units of time, it can achieve a delivery probability of at least pi.

Further, we define three optimization problems to improve applicability of the invention to the networks under consideration. First, in order to be energy efficient, source nodes need to transmit as little as possible. Based on this consideration, we can find the minimum value of the number of retransmissions that achieves the required delivery probabilities of the nodes. Second, in certain conditions the main criteria might be the delivery probability of the high priority nodes. They might require the highest possible delivery probability that can be achieved for the given network parameters. Third, in some applications of sensor or RFID networks, it may be desirable to have as many nodes as possible in the highest priority class.

Based on the above discussion, the optimization criteria can be summarized as
1. Minimize the total network traffic. Alternatively, minimize xᵢ for every Qᵢ.
2. Maximize the delivery probability of the nodes in the highest priority class.
3. Maximize the number of nodes that can be accommodated in the highest priority class

The invented method is applicable to the case where the nodes can transmit on different channels using, for example, CDMA. Unlike most of the existing work on multi-channel (CDMA) wireless networks, we consider interference among the packets sent on different channels when analyzing the packet delivery probability. Multi-packet detection in a CDMA environment is a challenging design issue and the methods of analyzing packet error rate taking into consideration the multiple-access interference is largely an open problem. We develop a general model that attempts to capture the effects of Multiple Access Interference (MAI) in the analysis of the packet error probability.

### DESCRIPTION OF DRAWINGS

Drawing 1 depicts a typical network setup and shows an abstraction of the components contained in each sensor node.

Drawing 2a depicts the scenario when an RFID reader transmits a stimulus pulse which energizes the RFID tags and causes them to transmit data.

Drawing 2b depicts the scenario where, if all the RFID tags respond as soon as they receive the stimulus pulse, the resulting transmissions will collide and the RFID reader device would not be able to decode any useful information.

Drawing 3 depicts the random retransmissions of each node within each interval ‘T’ based on its own local clock. There is no global time reference in the network however the figure shows it to highlight the fact that there is no global time synchronization between the nodes.

Drawing 4 depicts the transmissions by different nodes that belong to different priority classes. It shows that a node having a higher priority will transmit a higher number of times within the said interval than a node having a lower priority.

Drawing 5 shows a general scheme to allocate different channels to nodes requiring different priorities. The nodes in each priority class are allocated one of two channels. The ratio in which the nodes in each priority class are divided among the two communication channels is predetermined.

Drawing 6 depicts the case where multiple communication channels are used. The figure shows the case where the transmissions of different codes overlap. However, they do not cause errors in each other as they use different codes (different communication channels).

Drawing 7 depicts the condition under which the transmissions using different communications channels (codes) can cause errors in each other by interfering with each other. The figure shows the condition when, if more than three transmissions using the other channel overlap with a transmission of a particular channel, the resulting interference causes errors in the current transmission.

### DETAILED DESCRIPTION OF INVENTION

We consider a network architecture in which the data source nodes generate information and transmit it periodically to a central sink node as shown in Diagram 1. The set of n (>1) nodes are partitioned into m QoS classes, {Q₁, . . . Qₘ}, with each class containing (n₁, . . . , nₘ) nodes respectively. The packet arrival rates of the nodes in each class are {T₁, . . . , Tₘ} respectively and the frame transmission duration, t_{f}, of all the nodes is assumed to be the same. Each node in Qᵢ requires a minimum frame delivery probability of pᵢ (1<=i<=m). For simplicity, the groups are ordered such that, if i<j, then pᵢ≧pⱼ and Tᵢ≦Tⱼ. The core problem is to find the optimal number of retransmissions xᵢ for each Qᵢ, such that, if every node in Qᵢ transmits xᵢ times in every Tᵢ units of time, as shown in Diagram 3, it can achieve a delivery probability of at least pᵢ.
1. The Case Where All the Nodes in the Network Require the Same Delivery Probability (p₁=p₂= . . . =pₘ) and Only a Single Communication Channel is Used

In this case, all the nodes in the network need to achieve the same delivery probability. It is assumed that the source nodes generate data at a constant rate of one frame every ‘T’ units of time and the transmission time for each frame is much smaller than the inter-frame duration. Under this assumption the frame arrival rate can be modeled as a Poisson process. The number of nodes in the network is denoted by ‘n’ and the number of transmissions by each node in every interval ‘T’ is denoted by ‘x’.

Suppose that node i transmits a frame at time t₀ and the duration of the transmission is t_{f}. Assuming the signal propagation delay is negligible, none of the other n−1 nodes should transmit during the interval [t₀−t_{f}, t₀+t_{f}] in order that the frame does not collide and hence is successfully received by the destination node.

The frame arrival rate or the rate at which the source nodes generate the data can be modeled as a Poisson process and the probability that ‘k’ frames are transmitted in an interval ‘t’ is given by

$$P [ {n}^{′} = k ] = {\overline{e}}^{- λ t} \frac{{( λ t )}^{k}}{k !}$$

The probability that the frame transmitted by node i does not collide is the same as the probability that zero frames were transmitted by the other n−1 nodes in an interval 2t_{f}. This is given by

D^{nc}=e^{-2λt}^{_{f}}

Here λ is the rate of background traffic generated by the other n−1 nodes and is given by

$$λ = \frac{( n - 1 ) x}{T}$$

The above discussion presents the probability that a frame transmitted by node i is successfully received by the receiver. However, node i transmits ‘x’ copies of the frame at random instants in every time interval ‘T’. Hence the actual parameter of interest will be the probability that at least one of these ‘x’ copies is successfully received at the destination, which is defined as the delivery probability or QoS requirement of the node.

The delivery probability of each frame is given by

$$P ( x ) = 1 - {\prod }_{i = 1}^{x} ( 1 - {D}^{nc} )$$

which results in

$$P ( x ) = 1 - {( 1 - {e}^{\frac{- 2 x ( n - 1 ) {t}_{f}}{T}} )}^{x}$$

This expresses the delivery probability as a function of the number of transmissions attempted by each node in the interval ‘T’. Now, we can maximize the delivery probability with respect to the number of transmission. The delivery probability is maximized when

$$x = \frac{ln 2}{R}$$

where,

$$R = \frac{2 {t}_{f} ( n - 1 )}{T}$$

The maximum delivery probability that can be achieved is given by

$${P}_{max} = 1 - {( 1 - {e}^{- ln 2} )}^{\frac{ln 2}{R}}$$

The above result gives a relationship between the maximum delivery probability that can be achieved, the number of transmission attempts that each node makes in every interval ‘T’ and the number of nodes. By fixing any one variable we can design a network that is optimum in the other two variables. For example, if we fix the delivery probability requirement we can optimize the network to either have maximum number of nodes (maximize the number of users) or a minimum number of transmission attempts (minimize the energy consumption).
2. The Case Where Nodes in the Network Require Different Delivery Probabilities and Only a Single Communication Channel is Used

Proceeding with the analysis similar to that of the single QoS class case, the probability that a transmission from a node in Qᵢ does not collide with transmissions from any other node in the network is given by

Dᵢ^{nc}=e^{-2λ}^{ᵢ}^{t}^{_{f}}

Here the rate of the background traffic λᵢ is traffic generated per unit time by all other nodes in group i as well as all the nodes in the other groups and is given by

$${λ}_{i} = \frac{{n}_{1} {x}_{1} + {n}_{2} {x}_{2} + ⋯ + {n}_{m} {x}_{m} - {x}_{i}}{T}$$

The frame delivery probability achieved by a node in Qᵢ can then be expressed as

Pᵢ(xᵢ)=1−(1−e^{-2λ}^{ᵢ}^{t}^{_{f}})^{x}^{ᵢ}

In this case it is difficult to obtain a closed form expression for the maximum value of Pᵢ(xᵢ), since it depends on all xᵢ, iε{1, . . . , m}. Hence we formulate optimization problems based on the required network characteristics and solve for the different variables using known numerical methods.

We can optimize the above solution such that the number of transmission attempts made by each node is minimized hence minimizing the total network traffic. This will also result in higher energy efficiency of the nodes. The basic problem formulation is described as follows.

Given number of nodes in each group {n₁, . . . , nₘ} and the minimum delivery probability requirements of the groups {p₁, . . . , pₘ} we are required to find number of transmission to be attempted by each node in Gᵢ {x₁, . . . , xₘ} such that

$${\sum }_{i = 1}^{m} {n}_{i} \times {x}_{i}$$

is minimized, subject to

1−e^{-2λ}^{ⱼ}^{t}^{_{f}}−(1−pⱼ)^{1/x}^{ⱼ}≦0 j=1 . . . m

and

1≦xⱼ≦T/t_{f} j=1 . . . m

Alternatively, we can choose to maximize the delivery probability of the highest priority class (try to achieve as much as possible beyond the minimum required delivery probability) given {n₁, . . . , nₘ} and the minimum delivery probability requirement of the other groups {p₂, . . . pₘ} find the maximum achievable P₁(x₁) subject to the above mentioned constraints.

Thirdly, we can choose to maximize the number of nodes that can be accommodated in the highest priority class n₁ given the number of nodes in the other groups {n₂, . . . , nₘ} and {p₁, . . . , pₘ}.

One of the methods we can use (and have used) to achieve the above optimization goals is to formulate each and every optimization problem above as an NLP (Nonlinear programming, assuming xᵢ is a real number) or NLIP (Nonlinear Integer programming, assuming xᵢ is an integer) problem. The NLP and the NLIP problems can be solved by using existing software packages (e.g., Lingo and Matlab Optimization toolbox) or a custom developed program which implements a Brute force algorithm to obtain the solutions.
3. The Case Where Nodes in the Network Require Different Delivery Probabilities and Multiple Communication Channels are Used

We develop mathematical expressions for the delivery probability considering the use of CDMA. For ease of presentation of the ideas we first consider a specific case when there are two QoS classes Q₁ and Q₂ containing n₁ and n₂ nodes and requiring minimum delivery probability p₁ and p₂ (p₁>p₂) respectively. Each node can be assigned any one of two codes.

More specifically, we divide the nodes in class Q₁ into two sub-classes Q₁₁ and Q₁₂ which contain n₁₁ and n₁₂ nodes respectively, such that, n₁₁+n₁₂=n₁. The nodes in Q₁₁ are assigned code C₁ and those in Q₁₂ are assigned code C₂. Note that both the subgroups Q₁₁ and Q₁₂ require a minimum delivery probability of p₁. Similarly the nodes in class Q₂ are divided into two subgroups Q₂₁ and Q₂₂. Note that the subgroups Q₁₁, Q₂₁ and Q₁₂, Q₂₂ form two multiple QoS class systems.

However, they are not independent as the transmissions generated by one system (using C₁) interfere with and hence cause errors in the transmissions of the other system (using C₂). Diagram 5 and Diagram 6 show the transmissions of the nodes under such conditions. Now, we attempt to develop analytic formulae for the delivery probability of the nodes for the general case of ‘m’ QoS classes. Assume that a set of n nodes are partitioned into m QoS classes, {Q1, . . . , Qₘ}, with each class containing {n₁, . . . , nₘ} nodes respectively. As discussed above these classes are further divided into sub-classes {(Q₁₁,Q₁₂), . . . , (Qₘ₁;Qₘ₂)} such that the nodes in classes Qᵢ₁ use code C₁ and the nodes in classes Qᵢ₂ use code C₂. We restrict this discussion to the use of only two codes in order to facilitate the presentation.

Again, note that the subgroups {Q₁₁, . . . , Qₘ₁} and {Q₁₂, . . . , Qₘ₂} form two multiple QoS class system. The background network traffic for a node in Qᵢⱼ is defined as the traffic generated by all other nodes using the same code as the node and its rate is given by

$${λ}_{ij} = \frac{{n}_{1 j} {x}_{1 j}}{{T}_{1 j}} + \frac{{n}_{2 j} {x}_{2 j}}{{T}_{2 j}} + ⋯ + \frac{{n}_{mj} {x}_{mj}}{{T}_{mj}} - \frac{{x}_{ij}}{{T}_{ij}}$$

$$where i ∈ \{ 1 , … , m \} and j ∈ \{ 1 , 2 \} .$$

The interfering traffic is defined as the traffic generated by all the nodes using a different code and its rate is given by

$${λ}_{ij}^{′} = \frac{{n}_{1 {j}^{′}} {x}_{1 {j}^{′}}}{{T}_{1 {j}^{′}}} + \frac{{n}_{2 {j}^{′}} {x}_{2 {j}^{′}}}{{T}_{2 {j}^{′}}} + ⋯ + \frac{{n}_{{mj}^{′}} {x}_{{mj}^{′}}}{{T}_{{mj}^{′}}}$$

where j′ is the index of the other code (i.e.) if j=1, then j′=2 and vice versa.

Under this system configuration, the analysis of delivery probability has to take into account
1. Collisions between packets transmitted by nodes using the same code
2. Interference caused by the packets transmitted by nodes using a different code

To calculate the delivery probability, Pᵢⱼ, of a node nᵢⱼ we proceed as follows. First, we calculate the probability of one transmission being successful. This is given by the product of the probability that no transmission which uses that same code occurs in the interval (t₀−t_{f}; t₀+t_{f}) and the probability that interference due to transmissions using the other code does not cause an error. Let the probability that interference does not cause an error be denoted by Iⱼ. Hence the probability that one transmission is successful is given by

pₛ=p′ₛIⱼ

Each node transmits xᵢⱼ times in the interval Tᵢ. Thus the probability that all the xᵢⱼ transmissions are in error is

Pₑ=(1−pₛ)^{x}^{ᵢⱼ}

Thus the delivery probability, which is the probability that at least one of xᵢⱼ transmission is successful, is given by

$$\begin{matrix}{P}_{ij} = 1 - {P}_{e} \\ = 1 - {( 1 - {p}_{s}^{′} {I}_{j} )}^{{x}_{ij}} \\ {P}_{ij} = 1 - {( 1 - {e}^{( - 2 {λ}_{ij} {t}_{f} )} {I}_{j} )}^{{x}_{ij}}\end{matrix}$$

We claim:

1. An apparatus comprising a data sink having a data receiver, a plurality of source nodes, and a communication channel; wherein a said source node further comprises a data source, a buffer for data, and a data transmitter, but does not use any receiver to receive any information from the said data sink to the said source node; and wherein concurrent data transmissions by said source nodes will cause transmitted data to collide on the said communication channel and not be received by said data sink; the said apparatus further comprising means for setting the said data transmitter and means for the said source node to transmit its buffered data to the said data sink repetitively during a period of time to achieve a minimum data delivery performance.

2. The apparatus in claim 1 comprising a plurality of source nodes, wherein a first said source node does not use any receiver to receive any information from the said data sink to the said source node, and a second said source node, being different from the said first source node, uses a receiver to receive information from said the data sink;

3. The apparatus in claim 1 comprising means for the said data sink to activate a plurality of source nodes for a period of time, and means for said source nodes to transmit data to the said data sink multiple times during the activation period.

4. The apparatus in claim 1 comprising means for the said data sink to activate a plurality of source nodes for multiple periods of time, and means for setting a said source node to transmit once within an activation period with a certain probability p, and to not transmit within the said activation period with probability (1−p).

5. The apparatus in claim 1 comprising means for creating multiple channels using time, space, frequency and code division multiplexing, wherein said source nodes transmit data to said data sink on said multiple channels; the apparatus further comprising means for said data sink to receive data from said multiple channels, wherein the number of concurrent data transmissions by said source nodes that can be received by said data sink is smaller than the total number of said source nodes in said network.

6. The apparatus in claim 1 comprising means for setting said source nodes to belong to a plurality of priority classes; the said source nodes belonging to the same said priority class have the same minimum data delivery performance requirements; while the said minimum data delivery performance required by a higher priority class of said source nodes is better than the said minimum data delivery performance required by a lower priority class of said source nodes; the apparatus further comprising means for setting a higher priority source node to transmit more times than a lower priority source node during the said period of time.

7. The apparatus in claim 1 comprising means for assigning all said source nodes having same first minimum data delivery performance requirement, a first channel and assigning all said source nodes having same second minimum data delivery performance a second channel; the said second minimum data delivery performance requirement being different from the said first minimum data delivery performance requirement and said second channel being different from the said first channel.

8. The apparatus in claim 1 comprising means for assigning a first source node having a minimum data delivery performance requirement a first channel, and assigning a second source node having said minimum data delivery performance requirement a second channel; the said second source node being different from the said first source node, and said second channel being different from the said first channel.

9. The apparatus in claim 1 comprising means for determining the number of multiple transmissions by each said source node during said period of time using a computer program that minimizes the total number of transmissions by all said source nodes.

10. The apparatus in claim 1 comprising means for determining the number of multiple transmissions by each said source node during said period of time using a computer program that maximizes the data delivery probability of said source nodes having the same minimum data delivery performance requirement.

11. The apparatus in claim 1 comprising means for determining the number of multiple transmissions by each said source node during the said period of time using a computer program that maximizes the number of said source nodes having the same minimum data delivery performance requirement that can be networked together during said period of time.

12. The apparatus in claim 1 comprising means for the said source node to perform multiple transmissions at randomly chosen points in time during the said period.

13. The apparatus in claim 1 comprising means for setting the data transmitter of a first source node to a first on-off pattern during the said period, wherein the said transmitter transmits data once in the “ON” state and does not transmit in the “OFF” state, and setting the data transmitter of a second source node to a second on-off pattern during the said period; the said second source node being different from said first source node, and said second on-off pattern being different from said first on-off pattern.

14. A method for media access control in a network comprising a data sink having a data receiver, a plurality of source nodes, and a communication channel; wherein a said source node further comprises a data source, a buffer for data, and a data transmitter, but does not use any receiver to receive any information from the said data sink to the said source node; and wherein concurrent data transmissions by said source nodes will cause transmitted data to collide on the said communication channel and not be received by said data sink.

15. The method in claim 14 comprising means for setting the said data transmitter of each said source node to transmit its buffered data to the said data sink repetitively during a period of time to achieve a minimum data delivery performance.

16. The method in claim 14 comprising using the said data sink to activate a plurality of source nodes for a period of time, and setting said source nodes to transmit data to the said data sink multiple times during the activation period.

17. The method in claim 14 comprising using the said data sink to activate a plurality of source nodes for multiple periods of time, and setting a said source node to transmit once within an activation period with a certain probability p, and to not transmit within the said activation period with probability (1−p).

18. The method in claim 14 comprising creating multiple channels using time, space, frequency and code division multiplexing for the said source nodes to transmit data to said data sink, and setting the said data sink to receive data from said multiple channels, wherein the number of concurrent data transmissions by said source nodes that can be received by the said data sink is smaller than the total number of said source nodes in the said network.

19. The method in claim 14 comprising setting said source nodes to belong to a plurality of priority classes; the said source nodes belonging to the same said priority class have the same minimum data delivery performance requirements; while the said minimum data delivery performance required by a higher priority class of said source nodes is better than the said minimum data delivery performance required by a lower priority class of said source nodes; the method further comprising setting a higher priority source node to transmit more number of times than a lower priority source node during the said period of time.

20. The method in claim 14 comprising assigning all said source nodes having the same first minimum data delivery performance requirement a first channel, and assigning all said source nodes having the same second minimum data delivery performance a second channel; the said second minimum data delivery performance requirement being different from the said first minimum data delivery performance requirement, and said second channel being different from the said first channel.

21. The method in claim 14 comprising means for assigning a first source node having a minimum data delivery performance requirement a first channel, and assigning a second source node having said minimum data delivery performance requirement a second channel; the said second source node being different from said first source node, and said second channel being different from said first channel.

22. The method in claim 14 comprising determining the number of multiple transmissions by each said source node during the said period of time using a computer program that minimizes the total number of transmissions by all said source nodes.

23. The method in claim 14 comprising determining the number of multiple transmissions by each said source node during the said period of time using a computer program that maximizes the data delivery probability of said source nodes having the same minimum data delivery performance requirement.

24. The method in claim 14 comprising determining the number of multiple transmissions by each said source node during the said period of time using a computer program that maximizes the number of said source nodes having the same minimum data delivery performance requirement that can be networked together during the said period of time.

25. The method in claim 14 comprising setting the said source node to perform multiple transmissions at randomly chosen points in time during the said period of time.

26. The method in claim 14 comprising setting the data transmitter of a first source node to a first on-off pattern during the said period, wherein the said transmitter transmits data once in the “ON” state and does not transmit in the “OFF” state, and setting the data transmitter of a second source node to a second on-off pattern during the said period; the said second source node being different from said first source node, and said second on-off pattern being different from the said first on-off pattern.
